(19) United States
(12) Patent Application Publication
(10) Pub. No.: US 2017/0360168 A1
(43) Pub. Date: Dec. 21, 2017

(54) BAG AND REPLACEABLE PANEL SYSTEM

(71) Applicant: THERMOS L.L.C., Schaumburg, IL (US)

(72) Inventors: Dwayne Boroski, Lake in the Hills, IL (US); Lisa McQueeny, Schaumburg, IL (US)

(21) Appl. No.: 15/183,376

(22) Filed: Jun. 15, 2016

(51) Int. Cl. A45C 11/20; A47J 41/00

(52) U.S. Cl. CPC A45C 11/20; A47J 41/0066; A47J 41/0044; A47J 41/0061

(57) ABSTRACT

A bag and replaceable panel system is described. The bag and replaceable panel system provides a bag with a removable panel or lid that may be replaced with another removable panel. The user may use different panels depending on the user's preferred functional features or aesthetic characteristics.

### FIELD OF INVENTION

The present invention relates to a bag and replaceable panel system.

### BACKGROUND

Consumers often use bags to carry objects from one place to another. Such bags may be used to pack food (e.g., a lunch bag or lunchbox), supplies for a child (e.g., a diaper bag), or personal accessories (e.g., a purse or cosmetics bag). Many bags have a lid, which can be opened or closed, for example via a hinge, to permit the consumer to access the contents of the bag. In many bags, lids are static, meaning they are not intended to be removable or replaceable.

The lid of such typical bags may include a pocket or a sleeve, but such elements often cannot be changed to meet the needs of the specific use. For example, if a user wishes to store a drinking bottle in the lid one day and an ice pack in the lid another day, the items must conform the lid pocket-size and there is no opportunity to adapt the lid to the specific packing needs on a day to day or long term basis.

Also, bags are often adorned with images, patterns, or characters. Although the bags may still function properly, the bags may no longer be favored by the user due to a pattern that does not match the user's apparel or provide a seasonally-appropriate message, an image that does not express the user's preferred mood or environment (e.g. a professional image may be wanted for a work day and fun image wanted for a weekend picnic), or the character does not meet the whims of a child. Further, typical lunch bags and boxes are not customizable, for example, for different members of the same family or different needs on different days. Finally, users may simply enjoy or prefer the opportunity to customize their bag.

Clearly, there is a demand for a customizable bag. The present invention satisfies this demand.

### SUMMARY

A bag and replaceable panel system is described. One or more interchangeable panels may be used to close a bag. The user may remove a first panel from the bag and replace it with a second panel. While the examples discussed are configured generally as a lunch bag, the bag of the system may be a container or bag for any purpose. The bag and replaceable panel system includes a bag that may be customized to include different panels depending on the user's preferred functional features or aesthetic characteristics. Each panel is a lid or cover to close the bag.

In one aspect, a bag and replaceable panel system is described. The bag and replaceable panel system includes a bag defining a compartment. A bag zipper extends around a perimeter of the bag. The bag and replaceable panel system further includes a panel. A panel zipper extends around a perimeter of the panel. The panel zipper engages with the bag zipper to connect the panel to the bag. The panel zipper disengages from the bag zipper to completely disconnect the panel from the bag. The panel may be replaced with one or more different panels that engage to the bag zipper of the bag.

In another aspect, a bag and replaceable panel system is described. The bag and replaceable panel system includes a generally rectangular bag defining a compartment to hold food, drink containers, and/or personal items. The generally rectangular bag has one or more walls and a bottom wall. One example includes a first wall, a second wall, a third wall, and a fourth wall. The first wall is generally opposite of the third wall. The second wall is generally opposite of the fourth wall. The first and third walls have a longer length than a length of the second and fourth walls. The first wall, the second wall, the third wall, and the fourth side wall extend from the bottom wall. The first wall, the second wall, the third wall, and the fourth wall are integral with or attached to each other to form the outer boundary or sides of the bag. The upper edge of each of the first wall, second wall, third wall, and fourth wall form an upper perimeter of the bag. A bag zipper extends completely around the upper perimeter of the bag. The bag zipper is formed from a single, continuous length of a zipper material. The bag and replaceable panel system includes a panel sized and shaped to cover the compartment, for example, a generally rectangular panel. A panel zipper extends completely around an entire perimeter of the panel. The panel zipper is formed from a single, continuous length of a zipper material. The panel zipper engages with the bag zipper to removably connect and removably disconnect the panel from the bag such that the panel may be completely disconnected from the bag.

In another aspect, a bag and replaceable panel system is described. The bag and replaceable panel system includes a generally circular or elliptical bag defining a compartment to hold food, drink containers, and/or personal items. The generally circular bag has one continuous side wall and a bottom wall. The side wall extends up from a bottom wall. The side wall and bottom wall may be integral with each other or may be attached to each other. An upper edge of the side wall forms an upper perimeter of the bag. A bag zipper extends completely around the upper perimeter of the bag. The bag zipper is formed from a single, continuous length of a zipper material. The bag and replaceable panel system includes a panel sized and shaped to cover the compartment, for example, a circular or elliptical panel. A panel zipper extends completely around an entire perimeter of the panel. The panel zipper is formed from a single, continuous length of a zipper material. The panel zipper engages with the bag zipper to removably connect and removably disconnect the panel from the bag such that the panel may be completely disconnected from the bag.

In another aspect, a bag and replaceable panel system is described. The bag and replaceable panel system may include a bag and panel connectable via more than one zipper connection.

In another aspect, a bag and replaceable panel system is described. The bag and replaceable panel system may include a bag and panel configured to be connected via one or more panel fastener elements and complementary fastener elements positioned on the bag. Examples include complementary zipper teeth components, buttons and complementary button openings, snaps, clips, snap hooks, hooks & eyes, tack, hook & loop complementary components, stud & post, prong & socket, screw & bolt, or other types of complementary fastener pairs known in the art that permit easy removal and replacement of the panel relative to the bag.

In another aspect, a bag with an interchangeable panel system is described. The bag with an interchangeable panel system includes a bag defining a compartment. A bag zipper extends around a perimeter of the bag. A first panel is configured to close the compartment. A first panel zipper extends around a perimeter of the first panel. The first panel zipper engages with the bag zipper to connect the first panel to the bag. A second panel is configured to close the compartment after the first panel is disconnected from the bag. A second panel zipper extends around a perimeter of the second panel. The second panel zipper engages with the bag zipper to connect the second panel to the bag. As such, the first panel may be unzipped from the bag and replaced with the second panel. Typically, the second interchangeable panel includes at least one functional or aesthetic feature different than the features of the first interchangeable panel. For example, the first interchangeable panel may include no pocket, while the second panel includes a pocket on the exterior or interior surface, or the first interchangeable panel includes a first pattern on an exterior surface while the second interchangeable panel includes a second pattern on an exterior surface. Other features of one or more panels may include various pocket sizes, pocket shapes, pocket materials, pocket closure types, panel color, panel material, design on exterior surface of the panel, design on interior surface of the panel, panel insulation, or integrated ice element in the panel.

All aspects and embodiments of the disclosure can comprise, consist essentially of, or consist of any aspect or embodiment or combination of aspects and embodiments disclosed herein. Other aspects, embodiments, and iterations of the lid are described in more detail below.

### BRIEF DESCRIPTION OF DRAWINGS

FIG. 1 is a perspective view of an example of the bag and replaceable panel system with a first panel connected to the bag.

FIG. 2 is top view of an example of the bag and replaceable panel system showing the engagement between the first panel and the bag.

FIG. 3 is top view of an example of the bag and replaceable panel system showing the engagement between the second panel and the bag.

FIG. 4 is a perspective view of an example of the bag and replaceable panel system with the first panel disconnected from the bag.

FIG. 5 is a perspective view of an example of the second panel showing an interior pocket for holding an ice mat.

FIG. 6 is a close up view of an example of a panel zipper.

FIG. 7 is a close up view of an example of the panel zipper engaged to the bag zipper.

FIG. 8 is a close up view of an example of the panel zipper completely engaged to the bag zipper.

FIG. 9 is a perspective view of an example of the third panel having integral cooling media.

FIG. 10 is a perspective view of an example of the fourth panel having the exterior pocket.

FIG. 11 is a perspective view of a second example of the bag and replaceable panel system.

### DETAILED DESCRIPTION OF INVENTION

For purposes of this application, any terms that describe relative position (e.g., “upper”, “middle”, “lower”, “outer”, “inner”, “above”, “below”, “bottom”, “top”, etc.) refer to an embodiment of the invention as illustrated, but those terms do not limit the orientation in which the embodiments can be used.

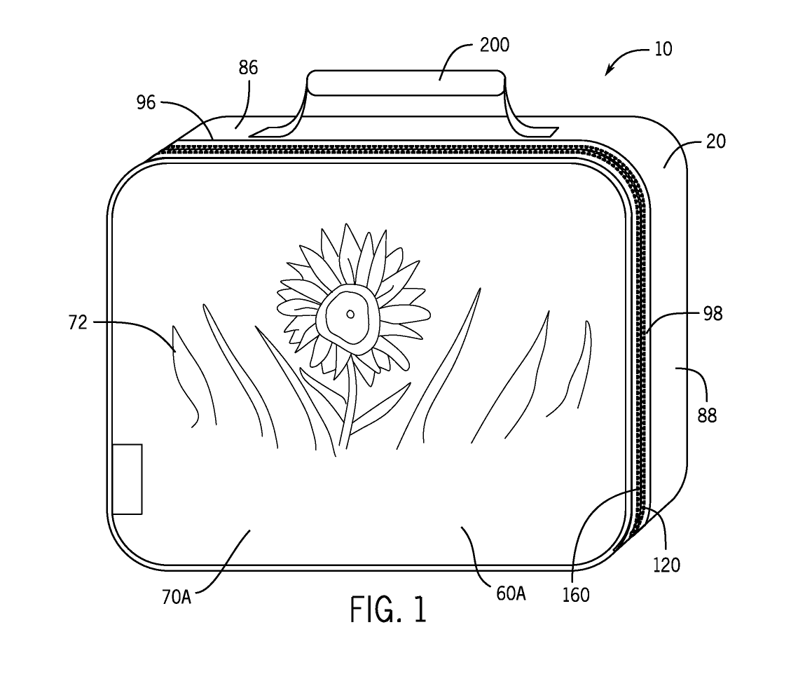

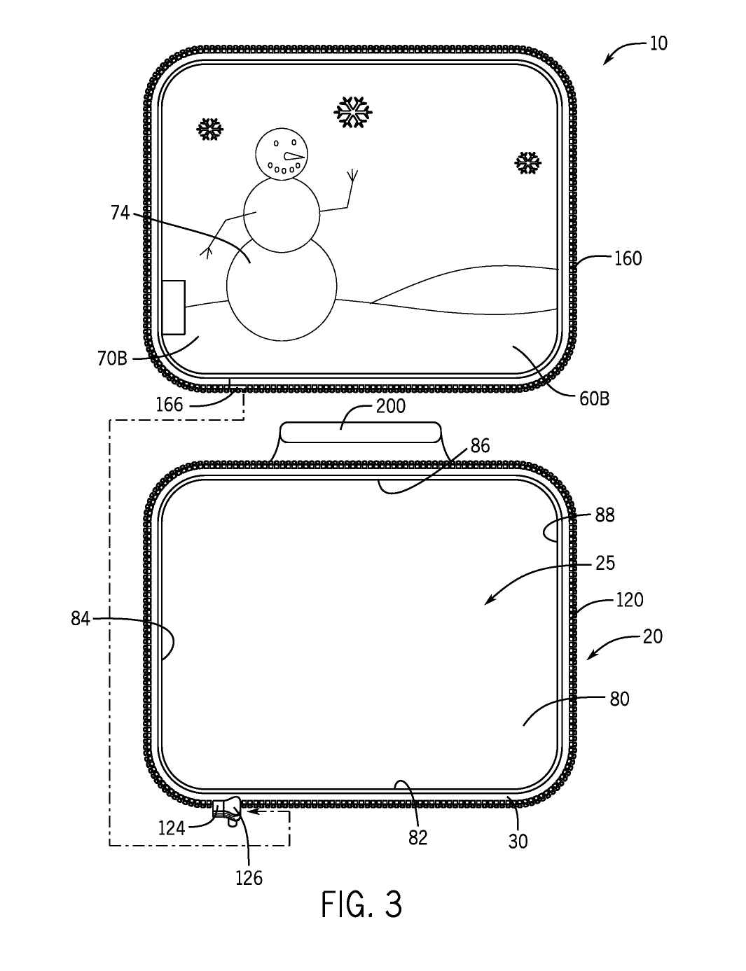

A bag and replaceable panel system 10 will now be described with reference to FIGS. 1-10. The bag and replaceable panel system 10 includes a bag 20 and one or more interchangeable panels 60. The bag 20 defines a compartment 25 configured to receive items such as food, drink, or other personal items. The one or more interchangeable panels 60 engage to the bag 20 to close off or cover the bag 20 and to maintain the items in the bag 20. A single bag 20 may be provided with or compatible with one or more of the interchangeable panels 60A, 60B, 60C, 60D, 60E or variations thereof.

The user may engage any of the interchangeable panels 60A-60E to the bag 20 depending on their preference or needs. For example, each of the interchangeable panels 60 may include different functional features or aesthetic characteristics. One interchangeable panel 60 may have no pockets and be lighter/easier to carry, while another interchangeable panel 60 may have pockets configured for various functions—possibly to hold an ice mat or to hold a drinking container, a sandwich, etc. Other interchangeable panels 60 may be sized and shaped to create a larger or smaller compartment 25 when connected to the bag 20.

Although the interchangeable panels 60 may be connected and disconnected to the bag 20, the bag and replaceable panel system 10 may still function similarly to typical lunch bags and boxes. For example, to access the compartment 25 of the bag 20, the user only needs to partially unzip the bag and replaceable panel system 10, and the remaining zipped portion provides a hinge for the then-connected panel 60 to be lifted to provide access to the compartment 25. Thus, the user is not required to completely remove the then-connected panel 60 in order to access the compartment 25.

As illustrated, the first interchangeable panel 60A includes an exterior surface 70A and an interior surface 71A. The exterior surface 70A includes a first design 72. The second interchangeable panel 60B includes an exterior surface 70B with a second design 74. The first design 72 is different from the second design 74. This provides the user the ability to customize their bag and replaceable panel system 10 as desired. The user may, for example, interchange the panel 60 etc. on a daily, weekly, etc. basis to suit their preference or needs. All of the panels 60A, 60B, 60C, 60D, 60E, etc. may engage to the same bag 20. As such, a single bag 20 may be used with one or more of the interchangeable panels 60A-60E to provide different aesthetic appearances or different functional characteristics.

The interchangeable panels 60 may include any of variety of ornamentation including media characters, athletic teams, pop-stars, branding, etc. The interchangeable panels 60 may include any of variety of decoration or designs, such as color schemes or patterns to complement or match a school back pack, a school uniform, school colors, etc. The interchangeable panels 60 may include any of variety of materials, colors, designs, etc. to match, coordinate, or complement the materials of the user's briefcases, purses, etc.

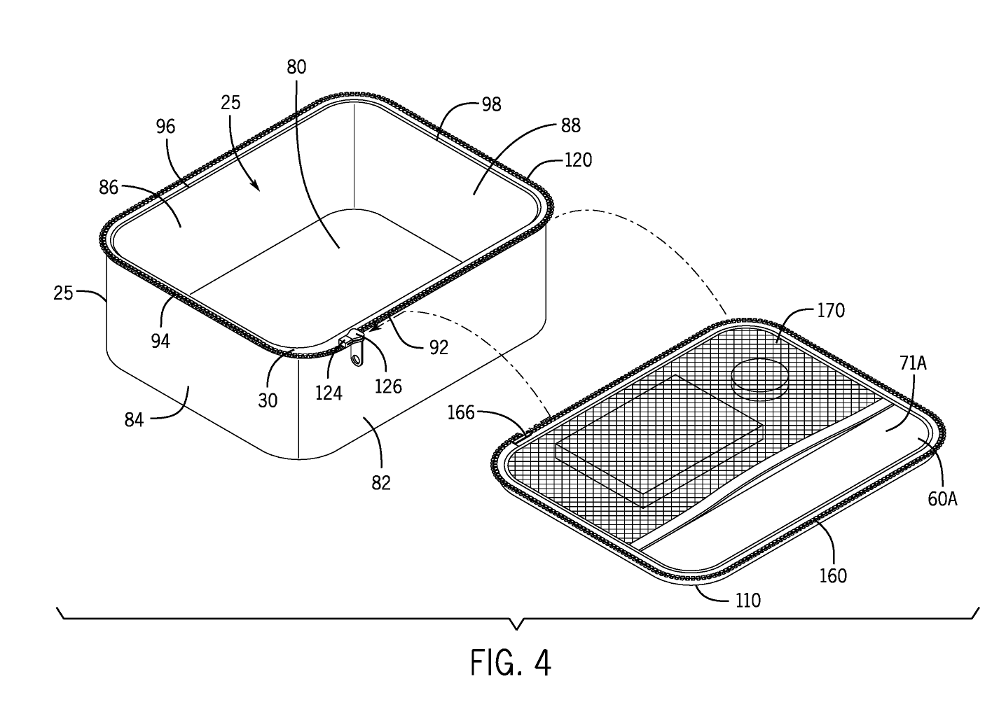

The bag 20 may include a box-like or bowl-like shape. The bag 20 may include an overall shape that is square, rectangular, circular, elliptical, etc. With reference to FIG. 4, the bag 20 is shown with a generally rectangular shape. The bag 20 includes a bottom wall 80. The bottom wall 80 may include or have adjacent to it a semi-rigid or flexible liner molded from a plastic material. A first wall 82 extends upward from the bottle wall 80. A second wall 84 extends upward from the bottom wall 80. A third wall 86 extends upward from the bottom wall 80. A fourth wall 88 extends upward from the bottom wall 80. The compartment 25 is formed defined by the interior of the walls 82, 84, 86, and 88. The walls 82, 84, 86, and 88 may be formed from layers of fabric materials, plastic materials, food-safe materials, or other materials appropriate for the use.

In the aspect of FIGS. 1-10, the first wall 82 and the third wall 86 form the longer, lateral sides of the generally rectangular shape. The bag 20 may include rounded corners between the walls 82, 84, 86, and 88. The second wall 84 and the fourth wall 88 form the shorter, end sides of the generally rectangular shape of the bag 20. The walls 82, 84, 86, and 88 are integral with each other or otherwise attached to each other. With reference to FIG. 4, the first wall 82 includes a first upper edge 92. The second wall 84 includes a second upper edge 94. The third wall 86 includes a third upper edge 96. The fourth wall 88 includes a fourth upper edge 98. The upper edges 92, 94, 96, and 98 are contiguous to form an upper perimeter 30 of the bag 20. A bag zipper 120 is positioned around the entire upper perimeter 30 of the bag 20.

The panel zipper 160 engages with the bag zipper 120 to connect the first interchangeable panel 60A to the bag 20, and the panel zipper 160 disengages from the bag zipper 120 to completely disconnect the first interchangeable panel 60A from the bag 20.

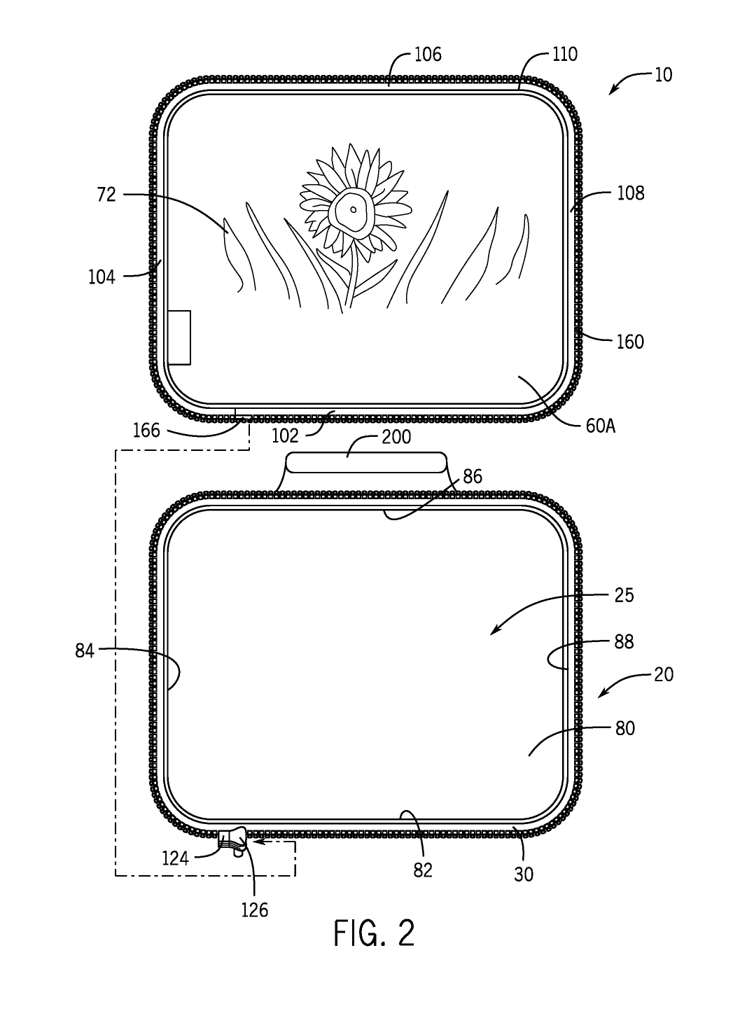

The first interchangeable panel 60A includes a generally rectangular shape to match the generally rectangular shape of the bag 20. With reference to FIG. 2, the first interchangeable panel 60A includes a first panel edge 102, a second panel edge 104, a third panel edge 106, and a fourth panel edge 108. The panel edges 102, 104, 106, 108 are contiguous with each other to form a panel perimeter 110. The panel zipper 160 may extend completely around the entire panel perimeter 110.

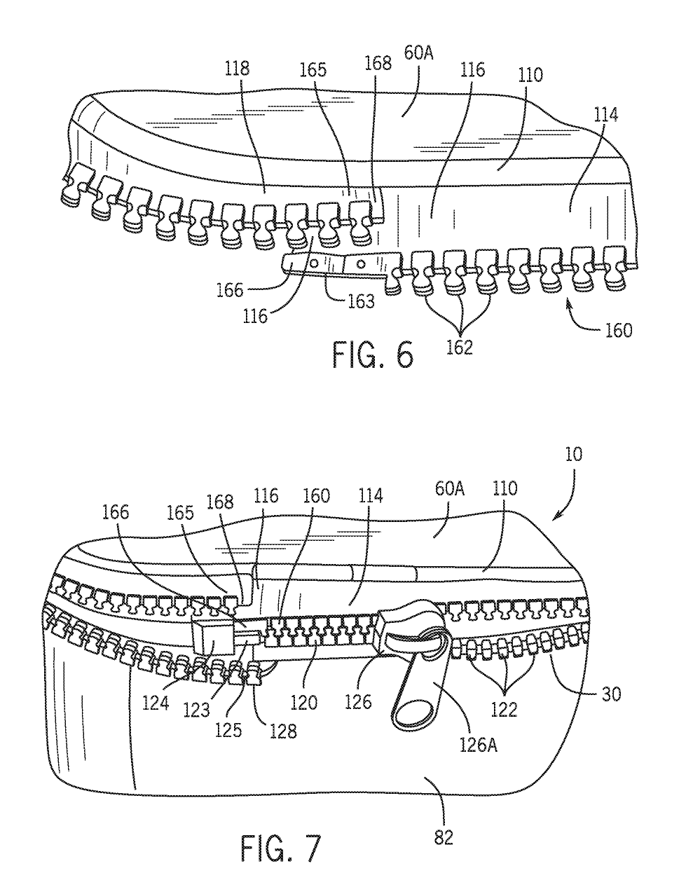

With reference to FIGS. 6-8, the bag zipper 120 includes a plurality of bag zipper teeth 122. A first end 123 of the bag zipper 120 includes a first end zipper connection element such as a zipper insertion pin 166 or a pin box 124. A second end 125 of the bag zipper 10 includes a bag zipper teeth end 128. A slider 126 is slideably engaged to the bag zipper 120. The pin box 124 may be overlapped by a portion of the bag zipper teeth 122 and/or the bag zipper teeth end 128. The bag zipper 120 may be formed from a single, continuous length of a zipper material. The bag zipper 120 may extend completely around the entire upper perimeter 30 of the bag 20.

The panel zipper 160 includes a plurality of panel zipper teeth 162. A first end 163 of the panel zipper 160 includes a first end zipper connection element such as a zipper insertion pin 166 or a pin box 124. The panel zipper 160 includes whichever first end zipper connection element complements or is compatible with the first end zipper connection element of the bag zipper 120. A second end 165 of the panel zipper 160 includes a panel zipper teeth end 168. The panel zipper 160 may be formed from a single, continuous length of a zipper material.

The pin box 124 of the bag zipper 120 receives and aligns the zipper insertion pin 166 of the panel zipper 160, to begin the connecting of the bag zipper 120 with the panel zipper 160. The slider 126 (with optional pull tab 126A) moves along a length of the bag zipper 120 and the panel zipper 160 to connect the bag zipper 120 with the panel zipper 160.

In the aspect of FIGS. 1-10, the panel zipper 160 is joined to the panel 60 via a seam 114, which extends from the panel perimeter 110. The seam 114 may vary in width. The seam 114 may be wider proximate the zipper insertion pin 166 at a first end 116 of the seam 114, while the seam 114 may be narrower proximate the panel zipper teeth end 168 at a second end 118 of the seam 114. A shown in FIG. 6, the seam 114 may extend around the entire panel perimeter 110. The seam 114 may extend around the entire panel perimeter 110 and also overlap it itself with the second end 118 of the seam 114 slightly over the first end 116 of the seam 114. The seam 114 may be formed by stitching, adhesive, or any method that would form an appropriate relationship between the panel zipper 160 and the panel 60.

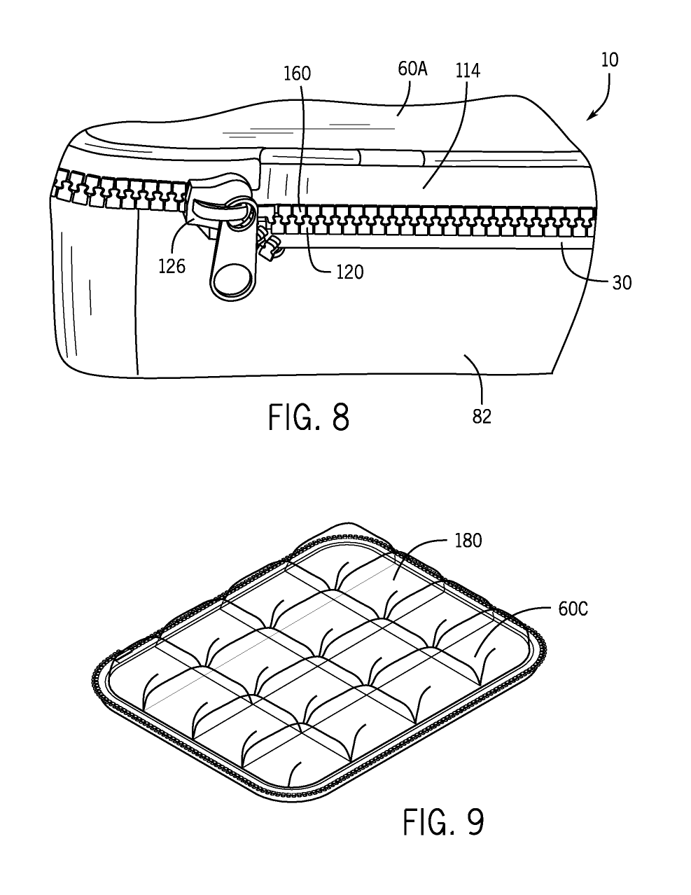

With reference to FIGS. 6-8, the panel zipper 160 may overlap itself, i.e., the panel zipper teeth end 168 may overlap the zipper insertion pin 166. Similarly, the bag zipper 120 may overlap itself, i.e., the pin box 124 may be behind the bag zipper teeth end 128. This overlapping provides for almost complete, complete or generally improved closure of the perimeter of the compartment 25 of the bag and replaceable panel system 10. As shown in FIG. 8, the slider 126 may pass over the pin box 124 and/or several of the bag zipper teeth 122 at the second end 125 of the bag zipper 120 when the slider 126 is moved a fully closed position (shown in FIG. 8). This provides for a cleaner and more finished appearance.

In order to the access the compartment 25 of the bag 20, the user only needs to partially unzip the bag and replaceable panel system 10, and the remaining zipped portion provides a hinge for the respective panel 60 to be lifted to provide access to the compartment 25. For example, the user may only unzip the panel zipper 160 from the bag zipper 120 along the second wall 84, the third wall 86, and the fourth wall 88, thus leaving the panel zipper 160 engaged to the bag zipper 120 along the first wall 82, which provides a hinge for the respective panel 60 to be lifted to an open position. Thus, the user is not required to completely remove the panels 60 in order to access the compartment 25.

In FIG. 8, the bag and replaceable panel system 10 is shown with the panel zipper 160 completely engaged to the bag zipper 120. In order to disconnect the panel 60A from the bag 20, the user moves the slider 124 to the left around the corner between the first side 82 and the second side 84. The user continues to move the slider 124 in a general clockwise direction along the second side 84, around the corner between the second side 84 and the third side 86, along the third side 86, around the corner between the third side 86 and the fourth side 88, along the fourth side 88, around the corner between the fourth side 82 and the first side 82, along the first side 82, and finally back to the pin box 124. Now, the panel 60A is disconnected from the bag 20.

With reference to FIG. 4, the interior surface 71A of the panel 60A may include an interior pocket 170 to hold a drinking container, a sandwich, snack bags, smaller containers, loose items, etc. Additional pockets, loops, fasteners may be employed to the interior surface 71A to hold such items.

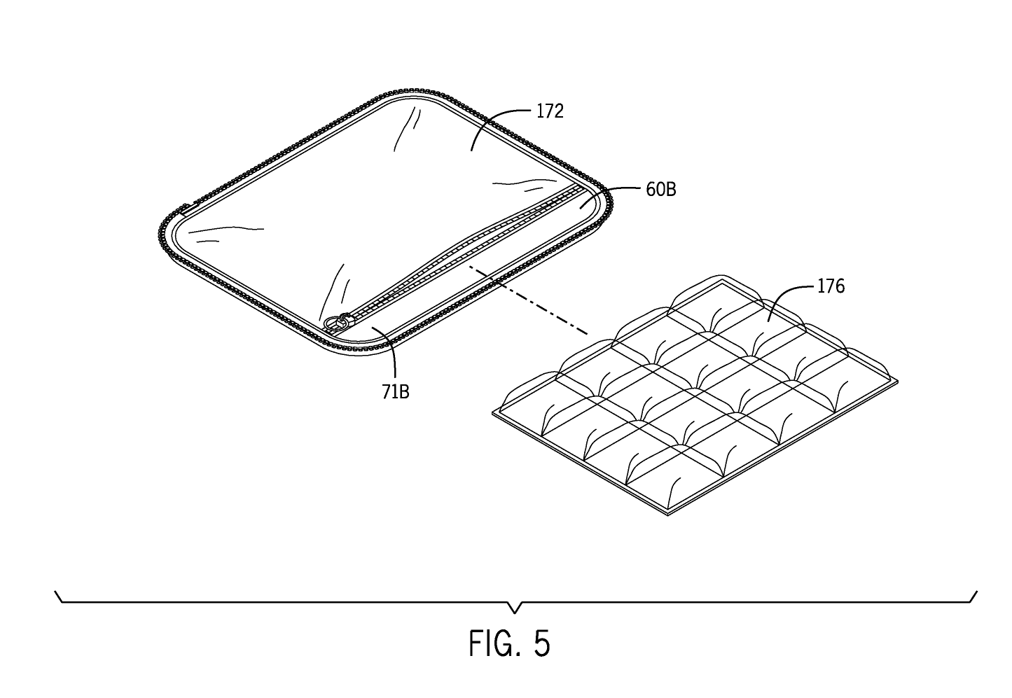

With reference to FIG. 5, the interior surface 71B of the panel 60B may include an interior pocket 172 to hold a cooling media, such as an ice mat 176 or other cooling device. Of course, one may use the interior pocket 172 to hold a drinking container, a sandwich, snack bags, smaller containers, loose items, etc. Certain aspects may include more than one interior pocket as well. Each interior pocket may be configured to hold various items, such as a first interior pocket configured to hold a sandwich, a second interior pocket configured to hold a drink container, etc. The interior pocket 172 may be formed from a breathable material or a non-breathable material or an elastic or non-elastic material. The interior pocket 172 may be generally sealable or have an unsealed open top. The interior pocket 172 may include an extendable section configured to extend the volume of the pocket to fit various types of items.

With reference to FIG. 9, the interchangeable panel 60C includes an integral cooling media 180. A coolant is built into and is not readily removable from the panel 60C. The interchangeable panel 60C may be completely removed from the bag 20 and stored in a refrigerator, freezer, or other cooling implement in order to cool or freeze the integral cooling media 180. After cooling, the interchangeable panel 60C may be engaged to the bag 20 to provide cooling to any of the items in the compartment 25. A user may replace the interchangeable panel 60C with another interchangeable panel 60C that has been cooled.

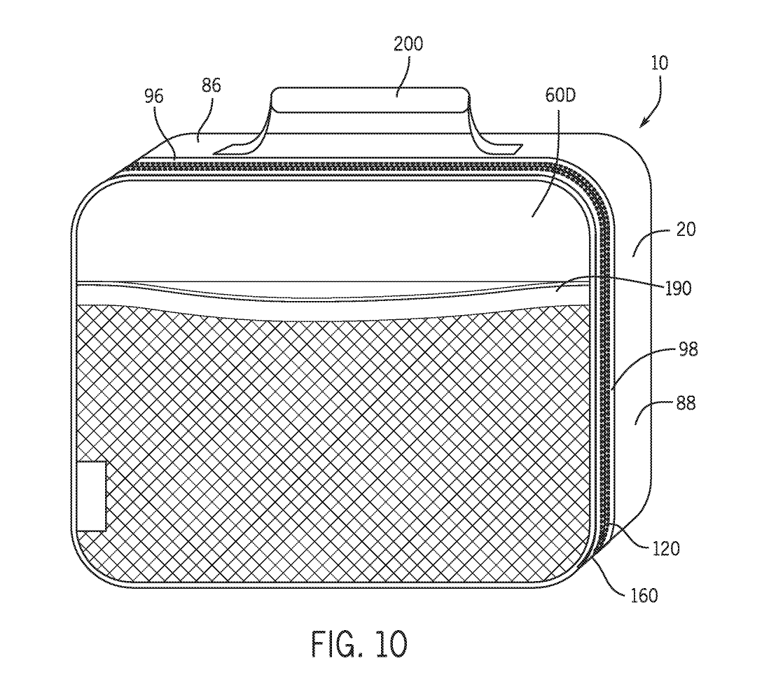

With reference to FIG. 10, the interchangeable panel 60D includes an exterior pocket 190. For example, items that do not require cooling, such as napkins, chips, utensils, etc. may be stored in the exterior pocket 190. The exterior pocket 190 may be formed from a breathable material or a non-breathable material. The exterior pocket 190 may be generally sealable or have an unsealed open top.

A carrying handle 200 may be engaged to one of the walls 82, 84, 86, and 88. In the aspect of FIGS. 1-10, the carrying handle 200 is engaged to the outer surface of the third wall 86. Additional carrying straps or handles may be engaged to one or more of the walls 82, 84, 86, and 88.

The panel zipper 160 and the bag zipper 120 may be formed from plastic and/or metal materials having interlocking teeth, tracks, coils, etc.

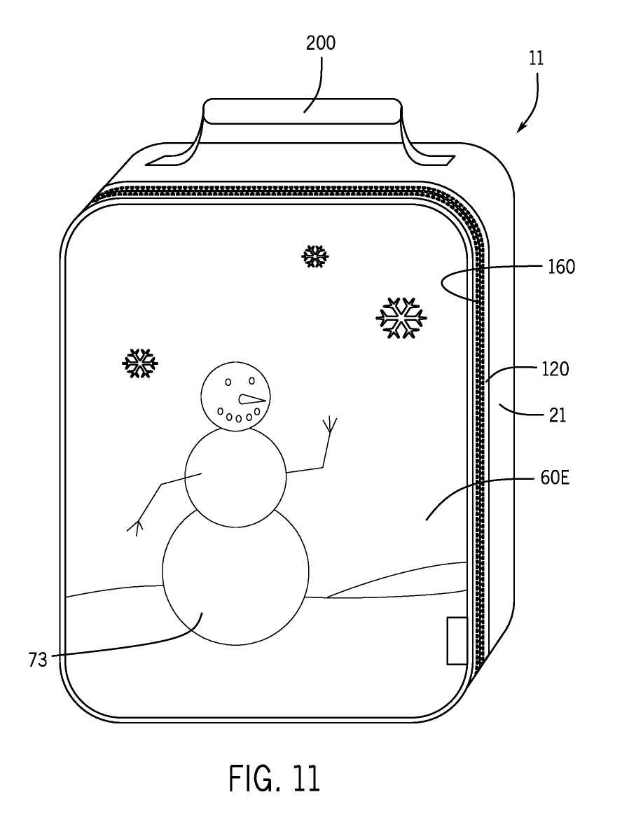

With reference to FIG. 11, a bag and replaceable panel system 11 is illustrated. Compared to the aspects presented in FIGS. 1 through 10, the same numbers are applied to the same parts in the bag and replaceable panel system 11, and descriptions of the same parts thereof are skipped. In this aspect, the bag and replaceable panel system 11 has a vertical orientation with the carrying handle 200 engaged to a shorter side of a bag 21. A panel 60E has a design 73 oriented in a vertical direction.

It should be understood that the disclosure is not limited to the particular aspects described herein, but that various changes and modifications may be made without departing from the spirit and scope of this novel concept as defined by the following claims. Further, many other advantages of applicant's disclosure will be apparent to those skilled in the art from the above descriptions and the claims below.

What is claimed is:

1. A bag and replaceable panel system, comprising:
a bag defining a compartment;
a bag zipper extending around a perimeter of the bag;
a first interchangeable panel to cover the compartment;
a panel zipper extending around a perimeter of the first interchangeable panel; and,
the panel zipper engages with the bag zipper to connect the first interchangeable panel to the bag; and the panel zipper disengages from the bag zipper to completely disconnect the first interchangeable panel from the bag.

2. The bag and replaceable panel system according to claim 1, wherein the bag zipper includes a plurality of bag zipper teeth, a first end of the bag zipper includes a pin box, a second end of the bag zipper includes a bag zipper teeth end, and a slider is slideably engaged to the bag zipper.

3. The bag and replaceable panel system according to claim 2, wherein the slider overlaps a portion of the bag zipper teeth, the pin box, or both the portion of the bag zipper teeth and the pin box.

4. The bag and replaceable panel system according to claim 1, wherein the panel zipper includes a plurality of panel zipper teeth, a first end of the panel zipper includes a zipper insertion pin, and a second end of the panel zipper includes a panel zipper teeth end.

5. The bag and replaceable panel system according to claim 1, further comprising a second interchangeable panel configured to engage with the bag in the same manner as the first interchangeable panel and having at least one feature different than the first interchangeable panel.

6. The bag and replaceable panel system according to claim 5, wherein at least one of the first interchangeable panel or the second interchangeable panel includes an interior pocket or an exterior pocket.

7. The bag and replaceable panel system according to claim 5, wherein at least one of the first interchangeable panel or the second interchangeable panel includes an integral cooling media.

8. The bag and replaceable panel system according to claim 1, wherein the bag zipper extends at least around the entire perimeter of the bag.

9. The bag and replaceable panel system according to claim 1, wherein the panel zipper extends at least around the entire perimeter of the first interchangeable panel.

10. The bag and replaceable panel system according to claim 5, wherein at least one of the first interchangeable panel or the second interchangeable panel has an interior pocket configured for holding an ice mat.

11. The bag and replaceable panel system according to claim 1, wherein, when the panel zipper is engaged with the bag zipper, a second end of the bag zipper overlaps a first end of the bag zipper and a second end of the panel zipper overlaps a first end of the panel zipper.

12. The bag and replaceable panel system according to claim 1, wherein, when the panel zipper is engaged with the bag zipper, a first end of the engaged zipper overlaps a second end of the engaged zipper.

13. The bag and replaceable panel system according to claim 1, wherein the bag includes a generally rectangular shape having a first wall, a second wall, a third wall, and a fourth wall; the first wall generally opposite of the third wall, the second wall generally opposite of the fourth wall; the first and third walls having a longer length than a length of the second and fourth walls; the first wall, the second wall, the third wall, and fourth wall extending from a bottom wall; the first wall, the second wall, the third wall, and fourth wall integral with or attached to each other and top edges of each wall collectively forms a perimeter of the bag, and the bag zipper positioned on the perimeter.

14. The bag and replaceable panel system according to claim 1, wherein the bag zipper includes a plurality of bag zipper teeth, a first end of the bag zipper includes a pin box, a second end of the bag zipper includes a bag zipper teeth end, and a slider is slideably engaged to the bag zipper, wherein the slider passes over the pin box when the slider is moved to a fully closed position at the second end.

15. The bag and replaceable panel system according to claim 1, wherein a seam joins the panel zipper to the panel, the panel zipper includes a plurality of panel zipper teeth, a first end of the panel zipper includes a zipper insertion pin, and a second end of the panel zipper includes a panel zipper teeth end, wherein the seam is wider proximate the zipper insertion pin at a first end of the seam, and the seam is narrower proximate the panel zipper teeth end at a second end of the seam.

16. A bag and replaceable panel system for a user, comprising:
a generally rectangular bag defining a compartment to hold food, drink containers, or personal items;
the generally rectangular bag having a first wall, a second wall, a third wall, and a fourth wall; the first wall generally opposite of the third wall, the second wall generally opposite of the fourth wall; the first and third walls having a longer length than a length of the second and fourth walls; the first wall, the second wall, the third wall, and the fourth wall extending from a bottom wall; the first wall, the second wall, the third wall, and the fourth wall are integral with or attach to each other and upper edge of each of the first wall, second wall, third wall, and fourth wall form an upper perimeter of the bag;
one or more fastener elements extending completely around the upper perimeter of the bag;
a first generally rectangular panel to cover the compartment;
one or more panel fastener elements extending completely around an entire perimeter of the panel; wherein the one or more panel fastener elements are complementary to the one or more fastener elements; and,
the one or more panel fastener elements engages with the fastener elements to removably connect and removably disconnect the panel from the bag such the panel may be completely disconnected from the bag by the user and such that the user may easily replace the first generally rectangular panel with a second generally rectangular panel; wherein the second generally rectangular panel has at least one feature different than the first generally rectangular panel.

17. A bag with an interchangeable panel system, comprising:
a bag defining a compartment;
a bag zipper extending around a perimeter of the bag;
a first panel to close the compartment;
a first panel zipper extending around a perimeter of the first panel;
the first panel zipper engages with the bag zipper to connect the first panel to the bag;
a second panel to close the compartment after the first panel is disconnected from the bag;
a second panel zipper extending around a perimeter of the second panel;
the second panel zipper engages with the bag zipper to connect the second panel to the bag; and,
wherein the first panel connects and disconnects to the bag via the bag zipper, and the second panel connects and disconnects to the bag via the bag zipper after the first panel is disconnected from the bag.

18. The bag with an interchangeable panel system according to claim 17, wherein the first panel has a first design, and the second panel has a second design, wherein the first design is different from the second design.

19. The bag with an interchangeable panel system according to claim 17, wherein the first panel has an interior pocket configured to hold an ice mat, wherein the second panel has an integral cooling media.

20. The bag with an interchangeable panel system according to claim 17, wherein the first panel or the second panel has an interior pocket.
